(19) United States
(12) Patent Application Publication
(10) Pub. No.: US 2013/0119801 A1
(43) Pub. Date: May 16, 2013

(54) BEARING ASSEMBLY AND FAN MOTOR INCLUDING THE SAME

(71) Applicants: Viatcheslav SMIRNOV, Suwon (KR); Chang Keun Jun, Suwon (KR); Duck Shik Kim, Suwon (KR)

(72) Inventors: Viatcheslav SMIRNOV, Suwon (KR); Chang Keun Jun, Suwon (KR); Duck Shik Kim, Suwon (KR)

(73) Assignee: SAMSUNG ELECTRO-MECHANICS CO., LTD., Suwon (KR)

(21) Appl. No.: 13/616,743

(22) Filed: Sep. 14, 2012

(30) Foreign Application Priority Data
Nov. 16, 2011 (KR) 10-2011-0119578

(51) Int. Cl. F16C 32/06; H02K 7/08

(52) U.S. Cl. 310/90; 384/119

(57) ABSTRACT

There is provided a bearing assembly including: a sleeve supporting a rotation of a shaft via dynamic fluid pressure generated in oil interposed therebetween; a boss rotating together with the shaft; and a sealing part including an oil sealing part disposed above the sleeve to seal the oil between the oil sealing part and the shaft and a gap forming part extended upwardly in an axial direction from the oil sealing part to form a gap preventing a leakage of the oil between the gap forming part and the boss.

### CROSS-REFERENCE TO RELATED APPLICATIONS

This application claims the priority of Korean Patent Application No. 10-2011-0119578 filed on Nov. 16, 2011, in the Korean Intellectual Property Office, the disclosure of which is incorporated herein by reference.

### BACKGROUND OF THE INVENTION

1. Field of the Invention

The present invention relates to a bearing assembly and a fan motor including the same, and more particularly, to a bearing assembly and a fan motor including the same capable of blocking an intake of foreign objects while preventing oil from being leaked so as to improve a performance thereof.

2. Description of the Related Art

Recently, small portable computers such as a notebook computer, and the like, have tended to be slim and light while having excellent levels of performance. In order to achieve the miniaturization and thinning of electronic products, implementing miniaturization, high speeds, and large capacities in central processing units (CPUs) used in computers and peripheral electronic devices is required.

As such, a capacity of electronic components, such as a miniaturized CPU, and the like, is relatively large and thus, a caloric value thereof is significantly increased. In order to prevent overheating of electronic components as an element having heat, a more rapid and efficient cooling device is required.

In particular, when operating, the CPU may reach a relatively higher temperature than that of other components, which may cause serious problems due to relatively high temperature thereof.

That is, with an increase in the temperature of the CPU, a clock rate may be reduced and malfunction and a failure occurrence rates may suddenly be increased.

At present, research into a method for effectively radiating heat from elements with heat such as the CPU, and the like, has been actively undertaken. As a result of this research, in the related art, a part of a cooling device, such as a fan motor, or the like, is mounted on a processor to rotate fan blades to cool the processor or other components generating large amounts of heat, and the like.

Meanwhile, in a cooling device, in the fan motor, a rotating member and a fixed member may be provided, and oil interposed therebetween may support rotation of the rotating member through fluid pressure generated therein. A fan motor according to the related art has a defect in that a fluid-air interface of the oil may deviate from a normal state due to expansion of the oil when the temperature thereof rises and thus, the oil is may be leaked. As a result, the performance of the fan motor may be deteriorated.

In particular, oil leakage may cause serious problems in the event that an external impact is applied to the fan motor, such that the lifespan thereof may be reduced.

Further, foreign objects may be introduced into a gap between the rotating member and the fixed member from the outside due to several factors. As a result, the rotational characteristics of the rotating member may be degraded due to the foreign objects.

Therefore, due to oil being leaked due to an oil temperature being increased or external impact being applied to a fan motor, research into blocking the intake of foreign objects from the outside while preventing oil from being leaked so as to have little effect on the performance of a fan motor has been urgently required.

### SUMMARY OF THE INVENTION

An aspect of the present invention provides a bearing assembly and a fan motor including the same, capable of blocking an intake of foreign objects from the outside while preventing oil from being leaked due to an external impact or an increase in temperature so as to improve performance and lifespan thereof.

According to an aspect of the present invention, there is provided a bearing assembly, including: a sleeve supporting a rotation of a shaft via dynamic fluid pressure generated in oil interposed therebetween; a boss rotating together with the shaft; and a sealing part including an oil sealing part disposed above the sleeve to seal the oil between the oil sealing part and the shaft and a gap forming part extended upwardly in an axial direction from the oil sealing part to form a gap preventing a leakage of the oil between the gap forming part and the boss.

The boss may be provided with a receiving part receiving the gap forming part, and the gap may be formed between the gap forming part and the receiving part.

The gap forming part and the boss may be consecutively formed in a circumferential direction.

A top surface of the oil sealing part may be inclined downwardly outwardly in a radial direction.

The gap between the oil sealing part and the shaft may widen upwardly in the axial direction to seal the oil and form a fluid-air interface between the oil and ambient air.

A predetermined area of an outer circumferential surface of the shaft facing the oil sealing part may have a diameter reduced upwardly in the axial direction.

The predetermined area of the outer circumferential surface of the shaft having the diameter reduced upwardly in the axial direction may have a different reduction rate.

The reduction rate of the diameter reduced upwardly in the axial direction may be larger in a lower portion than in an upper portion of the shaft.

An end of the predetermined area of the outer circumferential surface of the shaft having the diameter reduced upwardly in the axial direction may be inclined downwardly outwardly in the radial direction.

A predetermined area of a bottom surface of the boss facing a top surface of the oil sealing part may be provided with an oil leakage preventing part that is inclined downwardly outwardly in the radial direction.

At least one of opposing surfaces of the shaft and the oil sealing part may be provided with at least one oil reservoir provided to increase a size of an oil storage space.

The oil reservoir may be formed to be concave in an outer circumferential surface of the shaft.

The oil reservoir may be formed to be concave in an inner circumferential surface of the oil sealing part.

At least one of opposing surfaces of the gap forming part and the boss may be provided with at least one oil leakage blocking part for reintroducing the oil between the shaft and the oil sealing part when the oil sealed between the shaft and the oil sealing part is leaked to the gap between the boss and the gap forming part.

The oil leakage blocking part may be formed to be concave in an outer circumferential surface of the boss.

The oil leakage blocking part may be formed to be concave in an inner circumferential surface of the gap forming part.

According to another aspect of the present invention, there is provided a fan motor, including: a bearing assembly; a rotating part rotating together with the boss and including a magnet; and a fixed part coupled to the sleeve and including a core around which a coil generating rotational driving force through electromagnetic interaction with the magnet is wound.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a fan motor including a bearing assembly according to an embodiment of the present invention;

FIG. 2 is a schematic enlarged view of area A of FIG. 1;

FIG. 3 is a schematic enlarged view showing a first modified example of area A of FIG. 1;

FIG. 4 is a schematic enlarged view of area B of FIG. 3, wherein a movement of oil is schematically shown;

FIG. 5 is a schematic enlarged view showing a second modified example of area A of FIG. 1;

FIG. 6 is a schematic enlarged view showing a third modified example of area A of FIG. 1;

FIG. 7 is a schematic enlarged view showing a fourth modified example of area A of FIG. 1;

FIG. 8 is a schematic enlarged view showing a fifth modified example of area A of FIG. 1;

FIG. 9 is a schematic enlarged view of area C of FIG. 8, wherein a movement of oil is schematically depicted:

FIG. 10 is a schematic enlarged view showing a sixth modified example of area A of FIG. 1;

FIG. 11 is a schematic enlarged view of area D of FIG. 10, wherein a movement of oil is schematically shown;

FIG. 12 is a schematic enlarged view showing a seventh modified example of area A of FIG. 1;

FIG. 13 is a schematic enlarged view of area E of FIG. 12, wherein a movement of oil is schematically shown; and

FIG. 14 is a schematic enlarged view showing an eighth modified example of area A of FIG. 1.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of elements may be exaggerated for clarity, and the same reference numerals will be used throughout to designate the same or like elements.

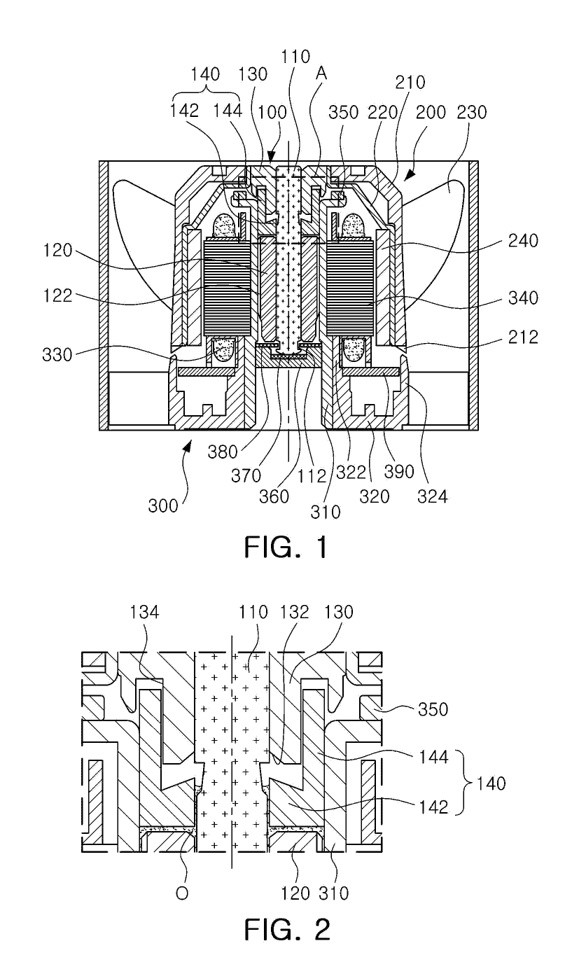

FIG. 1 is a schematic cross-sectional view of a fan motor including a bearing assembly according to an embodiment of the present invention and FIG. 2 is a schematic enlarged view of area A of FIG. 1.

Referring to FIGS. 1 and 2, a fan motor 400 including a bearing assembly 100 according to an embodiment of the present invention may include a bearing assembly 100, a rotating part 200, and a fixed part 300.

First, terms with respect to directions will be defined. As viewed in FIG. 1, an axial direction refers to a vertical direction based on a shaft 110, and a radial outside or inside direction refers to an outside direction of a hub 210 and a direction opposite thereto, based on the shaft 110.

In addition, a circumferential direction may be a rotating direction of the shaft 110, based on the shaft 110.

The bearing assembly 100 may include a sleeve 120 supporting a rotation of the shaft 110 via oil O, a boss 130 coupled to the shaft 110, and a sealing part 140 sealing the oil O between the sealing part 140 and the shaft 110.

In the fan motor 400 according to the embodiment of the present invention, the shaft 110 and the boss 130 may be one component of the rotating part 200, and the sleeve 120 may be one component of the fixed part 300 supporting the rotation of the rotating part 200, and these components will be described below by being considered as separate components.

The sleeve 120 may support the shaft 110 so that a top portion of the shaft 110 is protruded upwardly in an axial direction and may maintain a predetermined gap from the shaft 110.

Meanwhile, the gap may be filled with the oil O and the rotation of the shaft 110 may be stably supported by a radial dynamic pressure via the oil O.

In this configuration, the radial dynamic pressure via the oil O may be generated by a fluid dynamic part (not shown) concavely formed in an inner circumferential surface of the sleeve 120, wherein the fluid dynamic part may have a herringbone shape, a spiral shape, or a helix shape.

However, as described above, the fluid dynamic part is not necessarily formed in the inner circumferential surface of the sleeve 120. Therefore, it is to be noted that the fluid dynamic part may be formed in an outer circumferential surface of the shaft 110 and the number thereof is not limited.

Further, the sleeve 120 may be formed of a sintered body and may be a bearing in which oil is impregnated in the sintered body.

Therefore, in the fan motor 400 according to the embodiment of the present invention, a storage quantity of oil O due to the oil impregnated in the sleeve 120 may be significantly increased.

Here, the outer circumferential surface of the sleeve 120 may be provided with a circulating part 122, depressed inwardly from the outer circumferential surface thereof in an axial direction, wherein the circulating part 122 may be an oil-movement path allowing for air bubbles in the fan motor 400 to be discharged to the outside through a holder 310 by circulation, according to the embodiment of the present invention, to be described below.

In addition, the circulating part 122 may perform a balance adjusting function of dispersing an internal pressure in the fan motor 400 according to the embodiment of the present invention to maintain a balance.

The boss 130 may be partially coupled to the shaft 110 protruded above the sleeve 120 and may be rotated together with the shaft 110.

In this configuration, the boss 130 may be continuously formed in the circumferential direction and may be fixed to the hub 210 to be described below via a yoke 220.

In addition, the boss 130 may be provided with an oil leakage preventing part 132, wherein a predetermined area of a bottom surface of the oil leakage preventing part 132 facing a top surface of the oil sealing part 142 of the sealing part 140 is inclined downwardly outwardly in a radial direction so as to prevent the oil O from being leaked.

This will be described in detail after describing the sealing part 140.

In addition, the boss 130 may include a receiving part 134 receiving a gap forming part 144 of the sealing part 140, wherein the receiving part 134 may refer to a receiving space continuously formed in a circumferential direction.

Meanwhile, the receiving part 134 and the gap forming part 144 may be provided with a predetermined gap, and a length of a path communicating between the shaft 110 and the sleeve 120 may be significantly increased due to the gap.

In a case in which foreign objects are introduced between the shaft 110 and the sleeve 120 from the outside, the possibility of inflow of the foreign objects may be significantly reduced due to the extension of the oil-movement path.

This will be described in detail after describing the sealing part 140.

The sealing part 140 may be disposed above the sleeve 120, and in detail, may be disposed between the boss 130 and the sleeve 120.

In addition, the sealing part 140 may be fixed to a holder 310 and may seal the oil O between the sealing part 140 and the shaft 110.

In detail, the sealing part 140 may be provided with the oil sealing part 142 sealing the oil O between the sealing part 140 and the shaft 110 and the gap forming part 144 extending upwardly in the axial direction from the oil sealing part 142.

Here, the gap forming part 144 may form a gap between the gap forming part 144 and the boss 130 so as to prevent the oil O from being leaked. Consequently, the gap may be formed between the gap forming part 144 and the receiving part 134 formed in the boss 130.

Further, the gap formed between the gap forming part 144 and the receiving part 134 may be a length of the oil-movement path into which foreign objects are introduced from the outside .

That is, the possibility of the intake of foreign objects may be significantly reduced by extendedly forming the gap referring to the inflow path of foreign objects, thereby significantly reducing the degradation in performance of the fan motor 400 due to intake of the foreign objects.

Further, the sealing part 140 may be consecutively formed in the circumferential direction, which may indicate that the oil sealing part 142 and the gap forming part 144 are consecutively formed in the circumferential direction.

Meanwhile, a fluid-air interface of the oil O may be formed between the oil sealing part 142 and the shaft 110. To this end, the gap between the oil sealing part 142 and the shaft 110 may widen upwardly in the axial direction.

This is to prevent the oil O from being leaked due to a capillary phenomenon of a fluid. In order for the gap between the oil sealing part 142 and the shaft 110 to widen upwardly in the axial direction, a predetermined area of the outer circumferential surface of the shaft 110 facing the oil sealing part 142 may be formed to have a diameter reduced upwardly in the axial direction.

Further, the predetermined area of the outer circumferential surface of the shaft 110 having the diameter reduced upwardly in the axial direction may have a different reduction rate. Here, the reduction rate of the diameter reduced upwardly in the axial direction may be larger in a lower portion than in an upper portion of the shaft.

Here, the reduction rate is not necessarily constant. Therefore, it is to be noted that the reduction rate may be appropriately changed by those skilled in the art.

Further, the top surface of the oil sealing part 142 may be inclined downwardly outwardly in the radial direction, which may prevent the oil O from being leaked due to an external impact or the increase in temperature.

That is, when an external impact is applied and the temperature rises, the leakage of the oil O filled between the shaft 110 and the oil sealing part 142 to the outside may be significantly reduced by the inclined top surface of the oil sealing part 142.

Meanwhile, the predetermined area of the bottom surface of the boss 130 facing the top surface of the oil sealing part 142 may be provided with the oil leakage preventing part 132 downwardly inclined radially.

The oil leakage preventing part 132 may serve as a blocking wall blocking the leakage of the oil O when the oil O filled between the shaft 110 and the sleeve 120 is leaked due to an external impact, and the like.

Therefore, the degradation in the performance of the fan motor 400 according to the embodiment of the present invention due to the leakage of the oil O may be previously prevented by the oil leakage preventing part 132.

The rotating part 200 may include the yoke 220 coupled to the boss 130 and the hub 210 provided with an impeller 230.

The yoke 220, a component directly coupled to the boss 130, may serve as a medium in fixing the boss 130 and the hub 210.

Further, the yoke 220 may serve a guide guiding a flux flow of a driving magnet 240 coupled to the yoke 220 in a direction of a core 340 around which a coil 330 is wound.

In addition, the yoke 220 may generate magnetic attraction together with a suction magnet 350, such that the rotating part 200 may be rotated while maintaining a predetermined floating height.

Here, the driving magnet 240 may be provided to have an annular shape so as to be coupled to the inner circumferential surface of the yoke 220 and may be continuously formed in a circumferential direction.

The driving magnet 240 may provide a rotating driving force of the fan motor 400 according to the embodiment of the present invention by electromagnetic interaction with the coil 330 wound around the core 340 and may be rotated together with the rotation of the hub 210.

The outer circumferential surface of the hub 210 may be provided with the impeller 230. Air may move in one direction by the rotation of the hub 210 and the impeller 230.

In this case, the outer circumferential surface of the hub 210 may have a tapered shape in which a diameter thereof is gradually increased downwardly in the axial direction. Consequently, an end of the hub 210 may be disposed at a radial outside, that is, outside of a flange 324 of the base 320 in a radial direction.

Therefore, the performance of the fan motor 400 according to the embodiment of the present invention may be improved by securing the oil-movement path of air generated by the rotation of the impeller 230.

In addition, an end of the hub 210 may be provided with a pumping groove 212, wherein the pumping groove 21 may have a spiral or helix shape.

The pumping groove 212 may guide the flow of air from an internal space of a base 320 to an external space thereof. By the flow of air, the flow of air in a predetermined direction generated by the impeller 230 may smoothly provided.

The fixed part 300, a component coupled to the sleeve 120 to support the rotation of the rotating part 200, may include the core 340 around which the coil 330 is wound.

The core 340 around which the coil 330 is wound may be fixed to the sleeve 120 via the holder 310, wherein the holder 310 has a hollow into which the sleeve 120 is inserted, such that the holder 310 may be fixed to the sleeve 120.

A cover 360 may be fitted in the hollow of the holder 310 to axially support the shaft 110.

The cover 360 may seal a bottom portion of the sleeve 120 from the outside and may perform a sealing function of preventing the oil O filled between the shaft 110 and the sleeve 120 from being leaked to the outside.

Here, a thrust washer 370 may be disposed between the cover 360 and the bottom surface of the shaft 110 and may reduce a friction at the time of the rotation of the shaft 110.

In addition, a stopper 380 may be disposed in the holder 310. In detail, the stopper 380 is disposed on an upper portion of the cover 360 so as to be inserted into a locking groove 112 formed at the shaft 110.

Therefore, when the rotating part 200, including the shaft 110, is separated in an axial direction due to an external impact, and the like, the stopper 380 may be in contact with the locking groove 112 to prevent the separation of the rotating part 200.

Further, a top portion of the holder 310 may extend outwardly in a radial direction so as to be coupled to the suction magnet 350.

Here, the suction magnet 350 may generate the magnetic attraction together with the yoke 220 or the hub 210 having magnetism to rotate the rotating part 200 at a stable height.

As a result, the rotational characteristics of the fan motor 400 according to the embodiment of the present invention are improved and thus, noise or a waste of power occurring at the time of the rotation of the fan motor 400 at high speed may be prevented.

Further, the outer circumferential surface of the lower portion of the holder 310 may be coupled to the base 320, and the base 320 may be provided with a core seating part 322 protruded upwardly in the axial direction.

Therefore, a top surface of the core seating part 322 is provided with the core 340 seated thereon around which the coil 330 is wound, thereby improving an adhesion between the core 340 and the holder 310.

Meanwhile, a substrate 390 may be disposed on the base 320 and may allow power to be applied to the coil 330 wound around the core 340.

In detail, the substrate 390 may be disposed in an inner side of the flange 324 protruded upwardly in the axial direction from the outer end of the base 320, that is, in the internal space formed by the base 320.

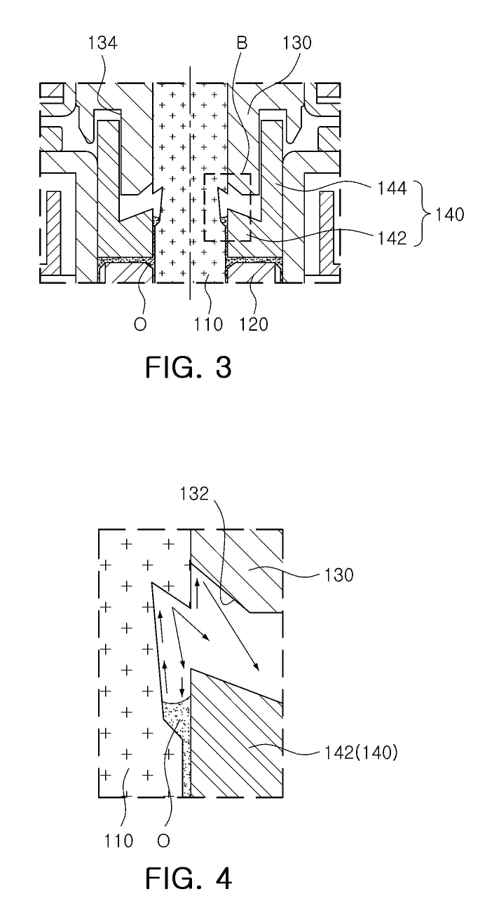

FIG. 3 is a schematic enlarged view showing a first modified example of area A of FIG. 1 and FIG. 4 is a schematic enlarged view of area B of FIG. 3, wherein the movement of the oil is schematically shown.

In embodiments described with reference to FIGS. 3 and 4, the description of the same components as those of the embodiments described with reference to FIGS. 1 and 2 will be omitted and only the different components in the embodiments will be described below.

Referring to FIGS. 3 and 4, the predetermined area of the outer circumferential surface of the shaft 110 facing the oil sealing part 142 of the sealing part 140 may have a diameter reduced upwardly in the axial direction, wherein the reduction rate thereof may be different.

Further, an end of the predetermined area of the outer circumferential surface of the shaft 110 having the diameter reduced upwardly in the axial direction may be inclined downwardly outwardly in the radial direction. This may prevent the leakage of the oil O due to an external impact or an increase in temperature, together with the oil leakage preventing part 132 formed in the bottom surface of the boss 130 facing the top surface of the oil sealing part 142.

In other words, as shown in FIG. 4, in a case in which the oil O is leaked due to an external impact or an increase in temperature, the possibility of the return of the oil O to the gap between the shaft 110 and the sleeve 120, that is, to an original position, may be significantly increased by the structural characteristic of the shaft 110 and the oil leakage preventing part 132.

Therefore, the degradation in the performance of the fan motor 400 according to the embodiment of the present invention due to the leakage of the oil O may be previously prevented by the structure of the shaft 110 and the oil leakage preventing part 132.

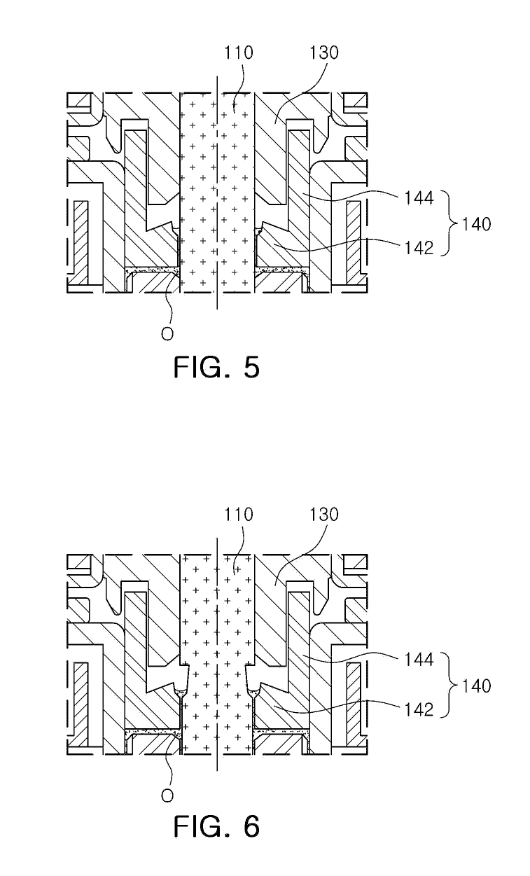

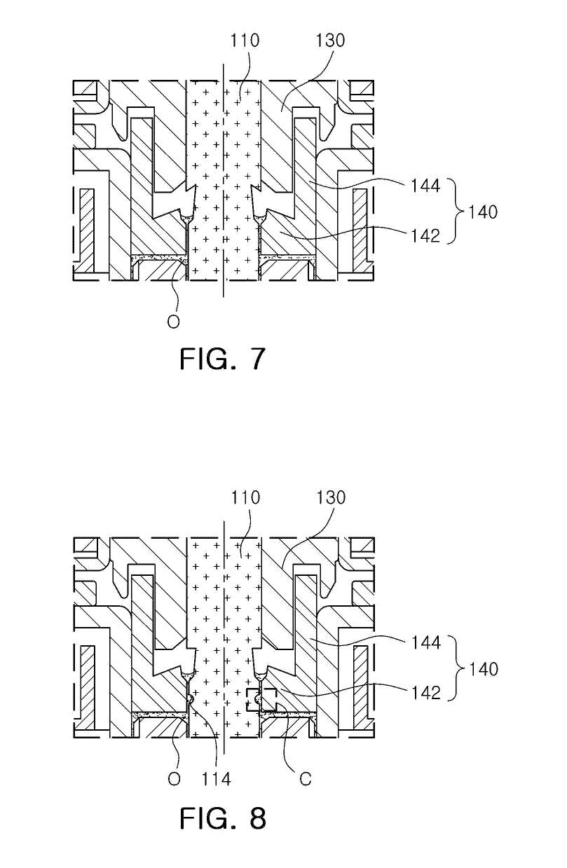

FIG. 5 is a schematic enlarged view showing a second modified example of area A of FIG. 1, FIG. 6 is a schematic enlarged view showing a third modified example of area A of FIG. 1, and FIG. 7 is a schematic enlarged view showing a fourth modified example of area A of FIG. 1.

Referring to FIG. 5, the fluid-air interface of the oil O may be formed between the oil sealing part 142 and the shaft 110. To this end, the gap between the oil sealing part 142 and the shaft 110 may widen upwardly in the axial direction.

That is, in order for the gap between the oil sealing part 142 and the shaft 110 to be increased upwardly in the axial direction, the predetermined area of the inner circumferential surface of the oil sealing part 142 corresponding to the outer circumferential surface of the shaft 110 may be formed to have a diameter increased upwardly in the axial direction.

In addition, referring to the embodiment of FIG. 6, in order for the gap between the oil sealing part 142 and the shaft 110 to be increased upwardly in the axial direction, the predetermined area of the inner circumferential surface of the oil sealing part 142 may be formed to have a diameter increased upwardly in the axial direction while the diameter of the outer circumferential surface of the shaft 110 being reduced upwardly in the axial direction.

In addition, the embodiment of FIG. 7 may be a combination of the embodiments of FIGS. 3 and 6 and the detailed description thereof will be omitted.

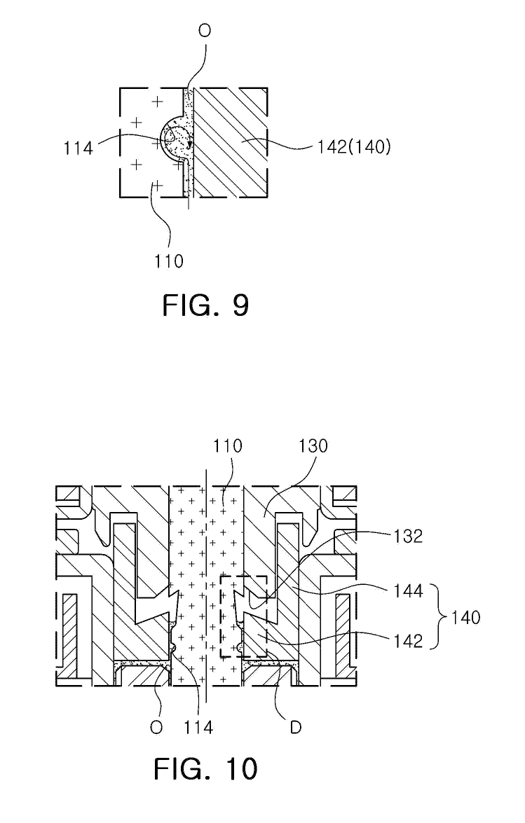

FIG. 8 is a schematic enlarged view showing a fifth modified example of area A of FIG. 1 and FIG. 9 is a schematic enlarged view of area C of FIG. 8, wherein a movement of oil is schematically shown.

First, FIGS. 8 and 9 show the embodiment in which the predetermined area of the inner circumferential surface of the oil sealing part 142 may be formed to have a diameter increased upwardly in the axial direction while the diameter of the outer circumferential surface of the shaft 110 being reduced upwardly in the axial direction, in order for the gap between the oil sealing part 142 and the shaft 110 to be increased upwardly in the axial direction. Therefore, it is to be noted that the present invention is not limited thereto and all the foregoing embodiments may be applied.

Referring to FIGS. 8 and 9, at least one of a surface of the shaft 140 opposing the oil sealing part 142 of the sealing part 140, and a surface of the oil sealing part 142 facing the surface of the shaft 140, may be provided with at least one oil reservoir 114 for increasing the storage space of the oil O.

The oil reservoir 114 may be formed to be concave in the outer circumferential surface of the shaft 110 and may be formed to be concave in the inner circumferential surface of the oil sealing part 142 although not shown.

Further, the oil reservoir 114 may be formed at both of the outer circumferential surface of the shaft 110 and the inner circumferential surface of the oil sealing part 142.

Therefore, the fan motor 400 according to the embodiment of the present invention may significantly increase the storage space of the oil O and prevent the leakage of the oil O due to the external impact or the increase in temperature, by the oil reservoir 114.

In other words, as shown in FIG. 9, when the oil O is leaked due to various factors, the oil reservoir 114 may serve as a blocking wall blocking the leakage of the oil O, such that the leakage possibility of the oil O may be significantly reduced.

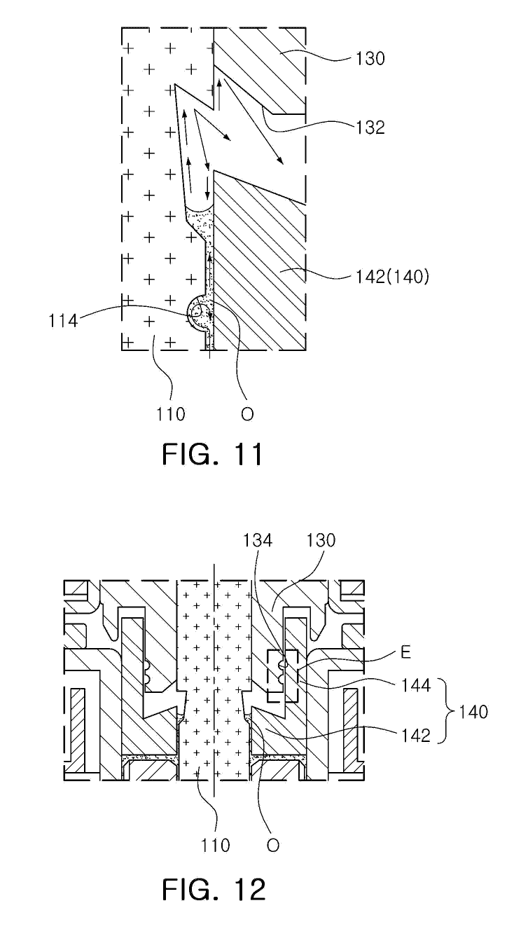

FIG. 10 is a schematic enlarged view showing a sixth modified example of area A of FIG. 1 and FIG. 11 is a schematic enlarged view of area D of FIG. 10, wherein a movement of oil is schematically shown.

First, FIGS. 10 and 11 show the embodiment in which the diameter of the outer circumferential surface of the shaft 110 is reduced upwardly in the axial direction, in order for the gap between the oil sealing part 142 and the shaft 110 to be increased upwardly in the axial direction. Therefore, it is to be noted that the present invention is not limited thereto and all the foregoing embodiments may be applied.

Referring to FIGS. 10 and 11, at least one of the outer circumferential surface of the shaft 110 and the inner circumferential surface of the oil sealing part 142 may be provided with the oil reservoir 114.

Further, an end of the predetermined area of the outer circumferential surface of the shaft 110 having the diameter reduced upwardly in the axial direction may be inclined downwardly outwardly in the radial direction.

As described above, this may prevent the leakage of the oil O due to the external impact or the increase in temperature, together with the oil leakage preventing part 132 formed in the bottom surface of the boss 130 facing the top surface of the oil sealing part 142.

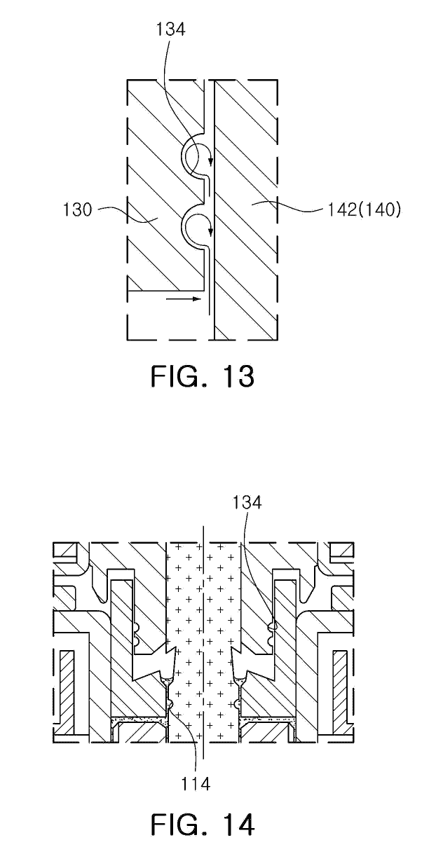

FIG. 12 is a schematic enlarged view showing a seventh modified example of area A of FIG. 1 and FIG. 13 is a schematic enlarged view of area E of FIG. 12, wherein a movement of oil is schematically shown.

First, FIGS. 12 and 13 are diagrams for describing an oil leakage blocking part 134 and it is to be noted that the oil leakage blocking part may be applied to all the foregoing embodiments.

Referring to FIGS. 12 and 13, at least one of a surface of the gap forming part 144 of the sealing part 140 opposing the boss 130, and a surface of the boss 130 facing the surface of the gap forming part 144, may be provided with at least one oil leakage blocking part 134 for reintroducing the oil O between the shaft 110 and the oil sealing part 142 when the oil O sealed between the shaft 110 and the oil sealing part 142 is leaked to the gap between the boss 130 and the gap forming part 144.

In detail, the oil leakage blocking part 134 may be formed to be concave in the outer circumferential surface of the boss 130 or may be formed to be concave in the inner circumferential surface of the gap forming part 144.

In addition, the oil leakage blocking part 134 may also be formed at both of the outer circumferential surface of the boss 130 and the inner circumferential surface of the gap forming part 144.

Therefore, as shown in FIG. 13, when the oil O is leaked due to various factors, the oil leakage blocking part 134 may serve as the blocking wall blocking the leakage of the oil O, such that the leakage possibility of the oil O may be significantly reduced.

FIG. 14 is a schematic enlarged view showing an eighth modified example of area A of FIG. 1.

Referring to FIG. 14, the fan motor 400 according to the embodiment of the present invention may include both of the oil reservoir 114 and the oil leakage blocking part 134 and the effect thereof may be the same as the foregoing embodiments.

The configuration and characteristics of the present invention describes the embodiments according to the present invention, but the present invention is not limited thereto and it would be apparent to those skilled in the art that various modifications and alterations might be made within the spirit and scope of the present invention. Therefore, it is to be noted that the medications and alternations are included in the scope defined in claims.

As set forth above, in the bearing assembly and the fan motor including the same according to the embodiment of the present invention, the power consumption due to the solid friction between the fixed part and the rotating part may be significantly reduced by preventing oil from being leaked due to the external impact or the increase in temperature.

In addition, according to the embodiment of the present invention, the rigidity of the bearing may be improved by blocking the intake of foreign objects from the outside, thereby significantly increasing the performance and lifespan thereof.

While the present invention has been shown and described in connection with the embodiments, it will be apparent to those skilled in the art that modifications and variations may be made without departing from the spirit and scope of the invention as defined by the appended claims.

What is claimed is:

1. A bearing assembly, comprising:
a sleeve supporting a rotation of a shaft via dynamic fluid pressure generated in oil interposed therebetween;
a boss rotating together with the shaft; and
a sealing part including an oil sealing part disposed above the sleeve to seal the oil between the oil sealing part and the shaft and a gap forming part extended upwardly in an axial direction from the oil sealing part to form a gap preventing a leakage of the oil between the gap forming part and the boss.

2. The bearing assembly of claim 1, wherein the boss is provided with a receiving part receiving the gap forming part, and the gap is formed between the gap forming part and the receiving part.

3. The bearing assembly of claim 2, wherein the gap forming part and the boss are consecutively formed in a circumferential direction.

4. The bearing assembly of claim 1, wherein atop surface of the oil sealing part is inclined downwardly outwardly in a radial direction.

5. The bearing assembly of claim 1, wherein the gap between the oil sealing part and the shaft is widened upwardly in the axial direction to seal the oil and form a fluid-air interface between the oil and ambient air.

6. The bearing assembly of claim 1, wherein a predetermined area of an outer circumferential surface of the shaft facing the oil sealing part has a diameter reduced upwardly in the axial direction.

7. The bearing assembly of claim 6, wherein the predetermined area of the outer circumferential surface of the shaft having the diameter reduced upwardly in the axial direction has a different reduction rate.

8. The bearing assembly of claim 7, wherein the reduction rate of the diameter reduced upwardly in the axial direction is larger in a lower portion than in an upper portion of the shaft.

9. The bearing assembly of claim 6, wherein an end of the predetermined area of the outer circumferential surface of the shaft having the diameter reduced upwardly in the axial direction is inclined downwardly outwardly in the radial direction.

10. The bearing assembly of claim 1, wherein a predetermined area of a bottom surface of the boss facing a top surface of the oil sealing part is provided with an oil leakage preventing part that is inclined downwardly outwardly in the radial direction.

11. The bearing assembly of claim 1, wherein at least one of opposing surfaces of the shaft and the oil sealing part is provided with at least one oil reservoir provided to increase a size of an oil storage space.

12. The bearing assembly of claim 11, wherein the oil reservoir is formed to be concave in an outer circumferential surface of the shaft.

13. The bearing assembly of claim 11, wherein the oil reservoir is formed to be concave in an inner circumferential surface of the oil sealing part.

14. The bearing assembly of claim 1, wherein at least one of opposing surfaces of the gap forming part and the boss is provided with at least one oil leakage blocking part for reintroducing the oil between the shaft and the oil sealing part when the oil sealed between the shaft and the oil sealing part is leaked to the gap between the boss and the gap forming part.

15. The bearing assembly of claim 14, wherein the oil leakage blocking part is formed to be concave in an outer circumferential surface of the boss.

16. The bearing assembly of claim 14, wherein the oil leakage blocking part is formed to be concave in an inner circumferential surface of the gap forming part.

17. A fan motor, comprising:
a bearing assembly of claim 1;
a rotating part rotating together with the boss and including a magnet; and
a fixed part coupled to the sleeve and including a core having a coil wound therearound generating rotational driving force through electromagnetic interaction with the magnet.
